(19) United States
(12) Patent Application Publication
(10) Pub. No.: US 2005/0188347 A1
(43) Pub. Date: Aug. 25, 2005

(54) Configurable and dynamically alterable object model

(76) Inventors: Karlheinz Dorn, Kalchreuth (DE); Hans-Martin Von Stockhausen, Erlangen (DE)

Correspondence Address: HARNESS, DICKEY & PIERCE, P.L.C., P.O.BOX 8910, RESTON, VA, 20195, US

(21) Appl. No.: 11/060,309

(22) Filed: Feb. 18, 2005

(30) Foreign Application Priority Data
Feb. 19, 2004 (DE) 10 2004 008 258.8

(51) Int. Cl. G06F 9/44

(52) U.S. Cl. 717/104

(57) ABSTRACT

A method and a system are for generating an object model for an application in an object-oriented environment. The system includes at least one generic component which reads in a configuration file and automatically generates an object model therefrom. The generic component also contains a repository which is intended for managing elements of the generated object model.

The present application hereby claims priority under 35 U.S.C. §119 on German patent application number DE 10 2004 008 258.8 filed Feb. 19, 2004, the entire contents of which is hereby incorporated herein by reference.

### FIELD OF THE INVENTION

The invention is in the field of object-oriented development of software-based systems and generally relates to a method for generating an object model for an application or for an application component. In contrast to functional and logical programming languages, which are problem-oriented, such as LISP, PROLOG, object-oriented programming languages, such as JAVA, C++, start from the elements of the problem posed, the objects, and their representation in the solution space. The application is not limited to a particular type of problem. Object-oriented approaches allow a broad spectrum of use on account of their high level of abstraction in relation to the solution to the problem.

### BACKGROUND OF THE INVENTION

The object-orientation paradigm is based on abstract constructs from the problem solution space, the objects which are characterized by properties (or the attributes) and their response (or the methods). One basic principle of object-oriented programming which may be mentioned is encapsulation. This principle states that methods from other classes can access the attributes only using object methods. It is thus possible to define who or what instances can access defined attributes and methods of the object and who cannot. By way of example, they may be ‘public’ and available to all or ‘private’ and can be used only within the object. A further, basic principle which may be mentioned is inheritance. This means that objects can be defined which are based on other objects by virtue of their inheriting the latter's methods and attributes. This produces a tree-like structure of classes.

In the course of the development of software components for different applications, particularly in the course of the object-oriented programming of software components, regions of overlap recurrently arise between the individual components which require a similar structure for the problem solution but have nevertheless needed to be implemented individually to date. This disadvantageously results in redundancies in the case of the solutions which are known from the prior art.

It is also necessary for a software-based system to be able to react flexibly to changes that are required without reducing the quality of the product. To date, it has been necessary for adaptation of the system to involve the object model requiring specific adaptation by replacing an original implementation component with a new, adapted implementation component.

The interchangeability of a component of an object model has to date needed to be achieved in the respective object model itself. This results in increased development and test costs, since individual adaptation has always been necessary and individual code has needed to be implemented in order to load modules which have changed, to generate objects or object instances which have changed and to insert these into the object model. These changes have meant that the entire system has needed to be freshly tested again.

### SUMMARY OF THE INVENTION

An object of an embodiment of the invention is to demonstrate a way of making an object model dynamically configurable and of making its objects interchangeable and extendable at runtime too without the need to change an existing implementation of the object model.

An object may be achieved by a method and a system for generating an object model for an application or for an application component in an object-oriented environment, where the method accesses a generic component which reads in a configuration file and generates an object model therefrom.

An object also may be achieved by an object model for an application or for a component of an application in an object-oriented environment which (object model) accesses a generic component which for its part reads in a configuration file, the object model being generated on the basis of processing of the configuration file.

An embodiment of the invention achieves an object by allowing the object model to be changed and/or adapted even after the actual design. This makes it possible to alter the object model at runtime too.

Individual implementation of change code is no longer necessary. Individual objects are merely removed from the object model or added.

One feature of an embodiment is that the inventive, generic component is fully independent of the application and/or of the application component. Above all, the generic component contains no application-related semantics and is therefore semantically independent of the respective application problem which is to be solved and/or independent of the object model which is to be generated. The generic component is based on a universal mechanism which is abstracted from the problem in a way which allows it to be used for different application components.

This makes it possible for no individual code to require implementation when the object model is subject to changes.

One provision is that the objects to be generated for the respective implementation, or the implementation objects, do not need to be inserted into the object model individually, or on a component-specific basis. At the starting time, the generic component reads in a configuration file and accesses at least one repository, which for its part is managed by the object model. The repository is intended for managing the instances and the interfaces for the respective objects. This results in significantly simplified development and greatly reduces the costs thereof.

The inventively generated object model, in at least one embodiment, preferably has a hierarchic structure. An object can access all interfaces which are on its level or which are in a hierarchic level below. This produces the advantage that the inventive solution supports the encapsulation principle. In one alternative embodiment, however, provision may be made for the encapsulation concept not to be covered.

A further advantage of the inventive solution of at least one embodiment which may be mentioned is that the object model is dynamically configurable, which means that, in particular, objects can be erased and removed from the generated object model. This is even possible at runtime too. This allows very flexible reaction to change requirements.

In order for the inventive system, particularly the generic component, to be able to produce the object model, it reads in the configuration file. This is preferably a file which contains instructions in Extensible Markup Language (XML). However, alternative embodiments provide other languages, for example having an HTML-based syntax, for this.

The configuration file which has been read in by the generic component includes at least data which relate to the following data records:
names of the modules,
names of the object instances which are to be generated,
at least visible interfaces for the object instances and/or data about relationships among the objects.

The objects and possibly their attributes and methods are preferably generated automatically by the generic component. In accordance with an embodiment of the invention, this is done by accessing the configuration file. In one alternative embodiment, however, it is likewise possible to make provision for the user to intervene in this operation and to monitor the generation of the object model in a controlling capacity and/or to execute it non-automatically to some extent.

The method additionally includes a further method step, namely the initialization of objects in the generated object model. In this case, it may be possible to set whether all of the objects are to be initialized and, if this is not the case, which of them are to be initialized.

The order for initializing the objects goes—in relation to the object model—from the inside to the outside and for objects on the same hierarchic level in the configuration order. This allows the initialization to proceed semi-automatically, with recourse to the inheritance concept.

Required changes can be made by accessing a change routine or by reading in a further configuration file, namely a change configuration file, in addition to the initial configuration file. The changes do not need to be made individually, that is to say separately for each component.

An important element besides the generic component is the object repository, which is intended for managing elements or modules in the object model. In this case, therefore, the object instances and the visible interfaces are managed. In a more complex embodiment of the invention, the object repository manages even more, such as further interfaces and/or data about class structure, messages etc. In one advantageous embodiments a plurality of object repositories are provided. In the preferred embodiment of the invention, the object repository is part of the generic component and is managed thereby.

The inventive embodiments of the method which have been described above may also be in the form of a computer program product with a computer-readable medium and with a computer program and associated program code means, the computer being prompted to carry out the inventive method described above after the computer program has been loaded.

An alternative means of achieving the object is a storage medium which is intended for storing the computer-implemented method described above and can be read by a computer.

### BRIEF DESCRIPTION OF THE DRAWINGS

The detailed description of the figures below discusses exemplary embodiments, which should not be understood as restrictive, with their features and further advantages with reference to the drawing, in which:

FIG. 1 shows an example of an object model generated in line with an embodiment of the invention, and

FIG. 2 shows an overview of the basic flow of a method based on an embodiment of the invention and of fundamental elements of the inventive system.

### DETAILED DESCRIPTION OF THE EXEMPLARY EMBODIMENTS

An object model, denoted generally by 10, is generated in line with an embodiment of the invention for an application A or for a portion or for a component of an application A. In this case, a generic component 12 is used which accesses a universal mechanism and can thus be used for various applications A and/or for associated object models 10.

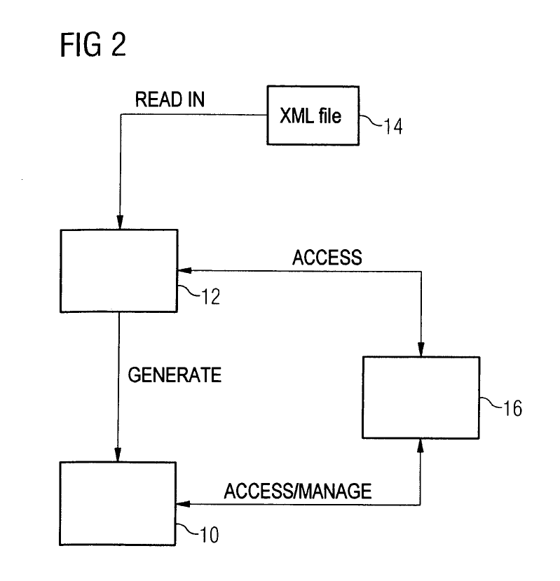

As FIG. 2 shows, the generic component 12 reads in a configuration file 14 at the starting time. The configuration file 14 is preferably available in the form of an XML file. The configuration file 14 stores the names of the modules, the names of the object instances which are to be generated and their visible interfaces and data about the relationships among the objects. This particularly involves management of which interfaces can be accessed from which objects and which cannot.

When these data have been read in and processed, the generic component 12 generates the object model 10. The generic component 12 also includes a repository 16.

The repository 16 can be physically arranged within the generic component. Alternatively, it is possible for the repository 16 to be arranged outside the generic component and for a means of access to be provided. The repository 16 is used to manage the object model 10, particularly the instances and the visible interfaces per object. Within the object model 10, each object is provided with an explicit logical name by which it can be addressed by the repository 16. The same class can be configured under various logical names, using respectively different interfaces.

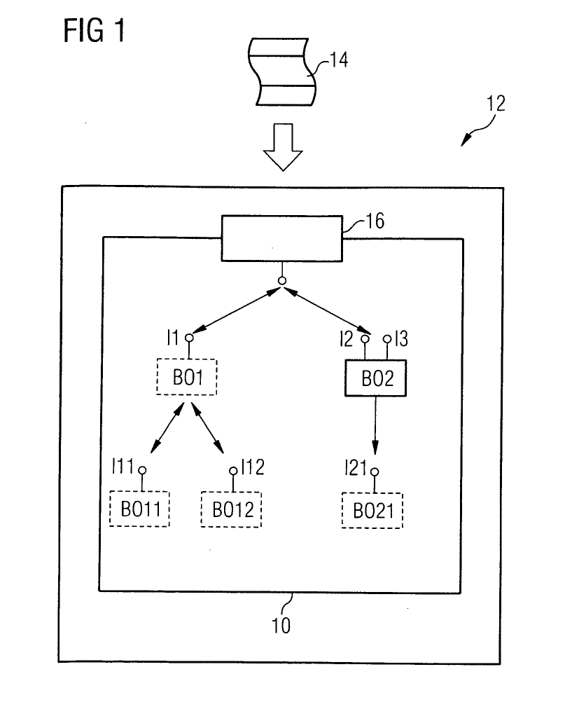

FIG. 1 shows an example of an object model 10 generated in line with the invention. The configuration file 14, shown merely by way of example, is used to generate the object model 10 within the generic component 12. The interfaces registered by the objects can each be seen among siblings, that is to say the objects which have the same origin, and from the original object. The origin of all objects is formed by the object repository 16. The object repository 16 is managed by the generic component 12.

At abstract level, the XML configuration file 14 might have the following appearance in order to generate the object model 10 shown in FIG. 1:

| | |
|---|---|
| <APPLICATION> | <BUSINESS_OBJECT LOGID=”BO1”...> |

| | |
|---|---|
| <INTERFACES> | <INTERFACE TYPE=”IBO1” /> |

| | |
|---|---|
| </INTERFACES> | <BUSINESS_OBJECT LOGID=”BO11” |
| ...> | <INTERFACES> |

<INTERFACE TYPE=”IBO11” />

</INTERFACES>

</BUSINESS_OBJECT>
<BUSINESS_OBJECT LOGID=”BO12” ...>

<INTERFACES>

<INTERFACE TYPE=”IBO12” />

</INTERFACES>

</BUSINESS_OBJECT>

</BUSINESS_OBJECT>
<BUSINESS_OBJECT LOGID=”BO2” ...>

<INTERFACES>

<INTERFACE TYPE=”IB02” />
<INTERFACE TYPE=”IBO3” />

</INTERFACES>
<BUSINESS_OBJECT LOGID=”BO21” ...>

<INTERFACES>

<INTERFACE TYPE=”IBO21” />

</INTERFACES>

</BUSINESS_OBJECT>

</BUSINESS_OBJECT>

</APPLICATION>

With comments and for a NET-based implementation of the method and/or system, the XML code which generates the object model 10 indicated in FIG. 1 reads as follows:

| | |
|---|---|
| <?xml version=”1.0” ?><APPLICATION> | <!--- |

Definition of a business object with logical name, type
(class name) and the DLL which contains it -->

| | |
|---|---|
| <BUSINESS_OBJECT | LOGID=”BO1” |

TYPE=”MyBusinessObjSpace.BO1”

ASSEMBLY=”MyBusinessObj1.d11”>
<!--- Interfaces which are implemented

by the object and need to be visible in the object
model -->

<INTERFACES>

<INTERFACE TYPE=”IB01” />

</INTERFACES>
<!--- nested business object (not

visible outside of the parent object -->

<BUSINESS_OBJECT LOGID=”BO11”

TYPE=”MyBusinessObjSpace.BO11”

ASSEMBLY=”MyBusinessObj11.d11”>
<INTERFACES>

<INTERFACE TYPE=”IBO11” />

</INTERFACES>

</BUSINESS_OBJECT>

<BUSINESS_OBJECT LOGID=”BO12”

TYPE=”MyBusinessObjSpace.BO12”

ASSEMBLY=”MyBusinessObj12.d11”>
<INTERFACES>

<INTERFACE TYPE=”IBO12” />

</INTERFACES>

</BUSINESS_OBJECT>

</BUSINESS_OBJECT>

<BUSINESS_OBJECT LOGID=”BO2”
TYPE=”BO2NameSpace.BO2”

ASSEMBLY=”BO2.d11”>
<INTERFACES>

<INTERFACE TYPE=”IBO2” />
<INTERFACE TYPE=”IBO3” />

</INTERFACES>

<BUSINESS_OBJECT LOGID=”BO21” TYPE=”MeinBONeu”

ASSEMBLY=”MeinBO.d11”>
<INTERFACES>

<INTERFACE TYPE=”IBO21” />

</INTERFACES>

</BUSINESS_OBJECT>

</BUSINESS_OBJECT>

</APPLICATION>

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for generating an object model for at least one of an application and a component of the application in an object-oriented environment, the method comprising:
accessing a generic component which reads in a configuration file and automatically generates an object model therefrom.

2. The method as claimed in claim 1, wherein the generic component is independent of at least one of the application and the application component.

3. The method as claimed in claim 1, wherein the implementation objects do not need to be inserted into the object model individually, or on a component-specific basis.

4. The method as claimed in claim 1, wherein the object model has a hierarchic structure.

5. The method as claimed in claim 1, wherein the object model is dynamically configurable, wherein objects are at least one of erasable from and added to the generated object model.

6. The method as claimed in claim 1, wherein the object model supports an encapsulation principle.

7. The method as claimed in claim 1, wherein the configuration file is an XML file.

8. The method as claimed in claim 1, wherein the method accesses at least one repository, managed by the object model and intended at least for managing instances and interfaces in relation to the respective objects.

9. The method as claimed in claim 1, further comprising:
initializing objects in the generated object model.

10. The method as claimed in claim 9, wherein the order for initializing the objects goes, in relation to the object model, from the inside to the outside and for objects on the same hierarchic level in the configuration order.

11. The method as claimed in claim 1, wherein the object model is changed by at least one of accessing a change routine and by reading in a change configuration file.

12. A system for generating an object model for at least one of an application and a component of the application in an object-oriented environment, the system comprising:
at least one generic component which reads in a configuration file and automatically generates an object model therefrom.

13. The system as claimed in claim 12, wherein the generic component is independent of at least one of the application and the application component.

14. The system as claimed in claim 12, wherein the implementation objects do not need to be inserted into the object model individually, or on a component-specific basis.

15. The system as claimed in claim 12, wherein the object model has a hierarchic structure.

16. The system as claimed in claim 12, wherein the object model is dynamically configurable, wherein objects are at least one of erasable from and added to the generated object model.

17. The system as claimed in claim 12, wherein the object model supports an encapsulation principle.

18. The system as claimed in claim 12, wherein the configuration file is an XML file.

19. The system as claimed in claim 12, further comprising:
at least one repository, managed by the object model and intended at least for managing instances and interfaces in relation to the respective objects.

20. The system as claimed in claim 12, further comprising:
at least one initialization unit, intended for initializing objects in the generated object model.

21. The system as claimed in claim 20, wherein the order for initializing the objects goes, in relation to the object model, from the inside to the outside and for objects on the same hierarchic level in the configuration order.

22. The system as claimed in claim 12, wherein the object model is changed by at least one of accessing a change routine and by reading in a change configuration file.

23. An object model for at least one of an application and an application component in an object-oriented environment, wherein the object model is one which has been automatically generated by access of a generic component which reads in a configuration file.

24. The object model as claimed in claim 23, wherein the object model is at least one of dynamically configurable, interchangeable and extendable, at least in terms of generated objects.

25. The method as claimed in claim 1, wherein the generic component is semantically independent of at least one of the application and the application component.

26. The method as claimed in claim 2, wherein the implementation objects do not need to be inserted into the object model individually, or on a component-specific basis.

27. The system as claimed in claim 12, wherein the generic component is semantically independent of at least one of the application and the application component.

28. The system as claimed in claim 13, wherein the implementation objects do not need to be inserted into the object model individually, or on a component-specific basis.

29. A computer program, adapted to, when executed on a computer, cause the computer to carry out the method as claimed in claim 1.

30. A computer program product, including the computer program of claim 29.
